(19) United States
(12) Patent Application Publication
(10) Pub. No.: US 2021/0150451 A1
(43) Pub. Date: May 20, 2021

(54) SYSTEMS AND METHODS FOR AUTOMATED MOBILE-DEVICE BASED WORK PERIOD TRADING

(71) Applicant: COUPANG CORP., Seoul (KR)

(72) Inventors: Ha Jeong JEONG, Seoul (KR); Seok Hun LIM, Seoul (KR)

(73) Assignee: COUPANG CORP.

(21) Appl. No.: 16/686,012

(22) Filed: Nov. 15, 2019

(51) Int. Cl. G06Q 10/06; G06Q 10/10

(52) U.S. Cl. CPC G06Q 10/063116; G06Q 10/0835; G06Q 10/1057; G06Q 10/06312

(57) ABSTRACT

A networked server system for automated personnel scheduling, comprising: at least one memory storing computer-executable instructions; and at least one processor configured to execute the stored instructions to: retrieve, from a first server, resource data for the predetermined time period; generate instructions for displaying an interactive graphical user interface including schedule information for a first user included in the resource data; receive a request from the first user to trade a shift during the predetermined time period; apply one or more rule sets to identify a candidate user in the resource data based on the received request; modify the interactive graphical user interface to provide the candidate user; receive a selection of the candidate user to initiate a shift trade; and update the resource data in real time to reflect the received selection and the traded shift.

### TECHNICAL FIELD

The present disclosure generally relates to computerized systems and methods for improved shift scheduling. In particular, embodiments of the present disclosure relate to inventive and unconventional systems allowing for exchange of leaves among individual delivery workers.

### BACKGROUND

Product delivery relies, to a great extent, on delivery workers to ensure that parcels are delivered to destinations on time. In a highly competitive market environment, the ability to deliver parcels in the shortest amount of time is highly desired. Therefore, when the availability of delivery workers is limited, their shifts must be scheduled carefully to ensure the required number of delivery workers are always present. One issue encountered in scheduling shifts is to ensure that each and every delivery worker is allowed adequate vacation time away from delivery. This poses a practical problem, because it is often the case that many delivery workers may have preferences for vacations time when there is a high demand for delivery, such that if the delivery workers are allowed to freely decide when to take their vacation times, these high demand days would lack the sufficient number of delivery workers to deliver the parcels.

Prior computerized systems address the above mentioned problem by having vacation time requests by the delivery workers subject to supervisory assignment and approval. A supervisor of a team of delivery workers must manually adjust shifts to accommodate the various vacation time requests from the delivery workers. The supervisor must take care to ensure that any vacation time request must not cause an insufficiency in the number of delivery workers, while doing the best to ensure that the delivery workers can have vacation times that are most desirable to them.

The prior art system is lacking because 1) it is a burden on the supervisor to manage shift scheduling, significant time may be spent on this problem that leads to inefficiency in the organization; 2) mistakes can be made by the supervisor in either approving vacation times that causes the delivery team to miss needed labor or denying vacation times when resources would otherwise be sufficient to cover the vacationing delivery worker.

Therefore, there is a need for a technical solution to enable more efficient and accurate shift scheduling.

### SUMMARY

One aspect of the present disclosure is directed to a system for automated personnel scheduling, comprising: at least one memory storing computer-executable instructions; and at least one processor configured to execute the stored instructions to: retrieve, from a first server, resource data for the predetermined time period; generate instructions for displaying an interactive graphical user interface including schedule information for a first user included in the resource data; receive a request from the first user to trade a shift during the predetermined time period; apply one or more rule sets to identify a candidate user in the resource data based on the received request; modify the interactive graphical user interface to provide the candidate user; receive a selection of the candidate user to initiate a shift trade; and update the resource data in real time to reflect the received selection and the traded shift.

Another aspect of the present disclosure is directed to a method for automated personnel scheduling, the method being performed by at least one processor of a networked server executing stored instructions to perform steps comprising: retrieving, from a first server, resource data for the predetermined time period; generating instructions for displaying an interactive graphical user interface including schedule information for a first user included in the resource data; receiving a request from the first user to trade a shift during the predetermined time period; apply one or more rule sets to identify a candidate user in the resource data based on the received request; modifying the interactive graphical user interface to provide the candidate user; receiving a selection of the candidate user to initiate a shift trade; and updating the resource data in real time to reflect the received selection and the traded shift.

Yet another aspect of the present disclosure is directed to a computerized method for automated personnel scheduling, the method being performed by at least one processor of a networked server executing stored instructions to perform steps comprising: determining, using order data received from a networked order database, a quantity of parcels to be delivered during a predetermined time period; determining, based on the quantity of parcels, a predicted workload for the predetermined time period; generate instructions for displaying an interactive graphical user interface including: schedule information for a first user included in the resource data; and one or more interactive graphical elements for initiating and accepting changes to the schedule information; receive, via selection of the one or more interactive graphical elements, a request from the first user to trade a shift during the predetermined time period; apply one or more rule sets to identify a candidate user in the resource data based on the received request, wherein the one or more rule sets filters a set of users based on a starting time and an ending time of the shift, and filters the set of users based on a predetermined productivity capability of the first user; modify the interactive graphical user interface to provide the candidate; receive a selection of the candidate to initiate a shift trade; and providing an electronic notification to the first user and the selected candidate, the electronic notification reflecting the shift trade.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a flow chart of an exemplary embodiment of shift scheduling of delivery workers which assigns vacation times, consistent with the disclosed embodiments.

FIG. 4 depicts a flow chart of a process for trading of vacation time among the delivery workers, consistent with the disclosed embodiments.

FIG. 5A depicts an interactive user interface for display to a user intending to perform vacation trading, consistent with the disclosed embodiments.

FIG. 5B depicts an interactive user interface configured to allow the first user to provide input to labor management system (LMS), consistent with the disclosed embodiments.

FIG. 5C depicts an interactive user interface comprising one or more calendars, consistent with the disclosed embodiments.

FIG. 5D depicts an interactive user interface enabling a user to select desired vacation time, consistent with the disclosed embodiments.

FIG. 5E depicts an interactive user interface of a list of eligible trades, consistent with the disclosed embodiments.

FIG. 5F depicts an interactive user interface including a confirmation, consistent with the disclosed embodiments.

FIG. 5G depicts an interactive user interface including an error message, consistent with the disclosed embodiments.

FIG. 5H depicts an interactive user interface including a confirmation message, consistent with the disclosed embodiments.

FIG. 5I depicts an interactive user interface including a list of vacation trade requests, consistent with the disclosed embodiments.

FIG. 5J depicts an interactive user interface including a prompt to cancel pending trade requests previously submitted, consistent with the disclosed embodiments.

FIG. 5K depicts an interactive user interface including a solicitation for approval to a second user, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for vacation trading.

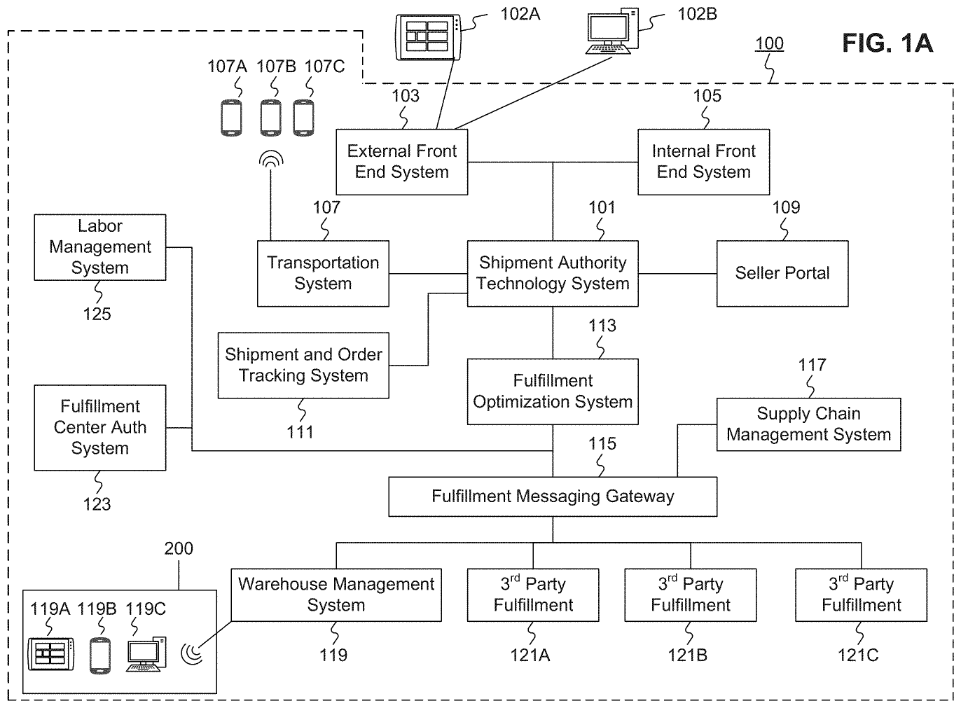

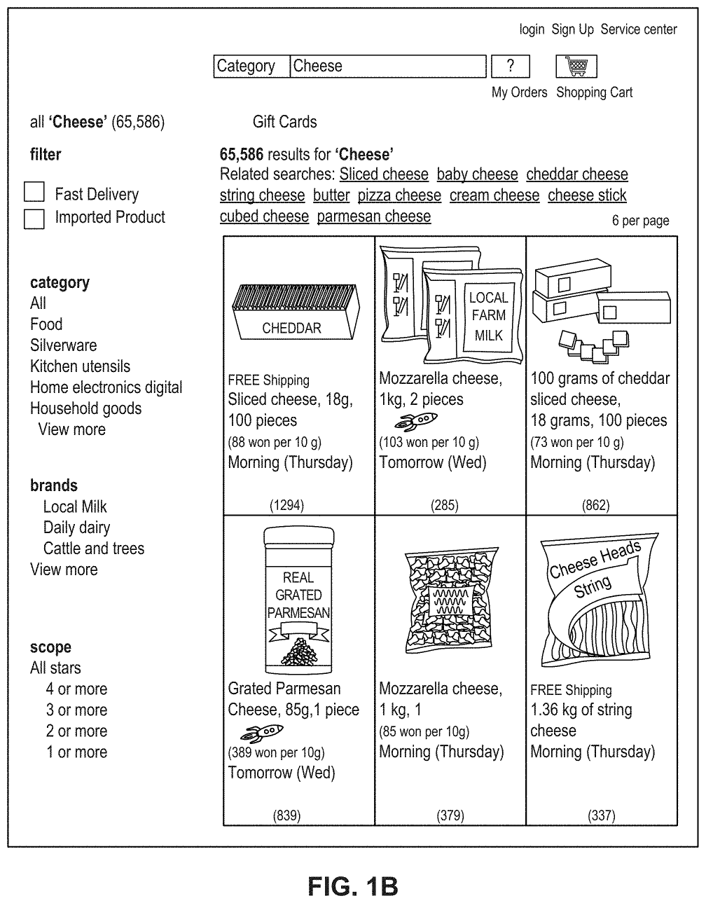

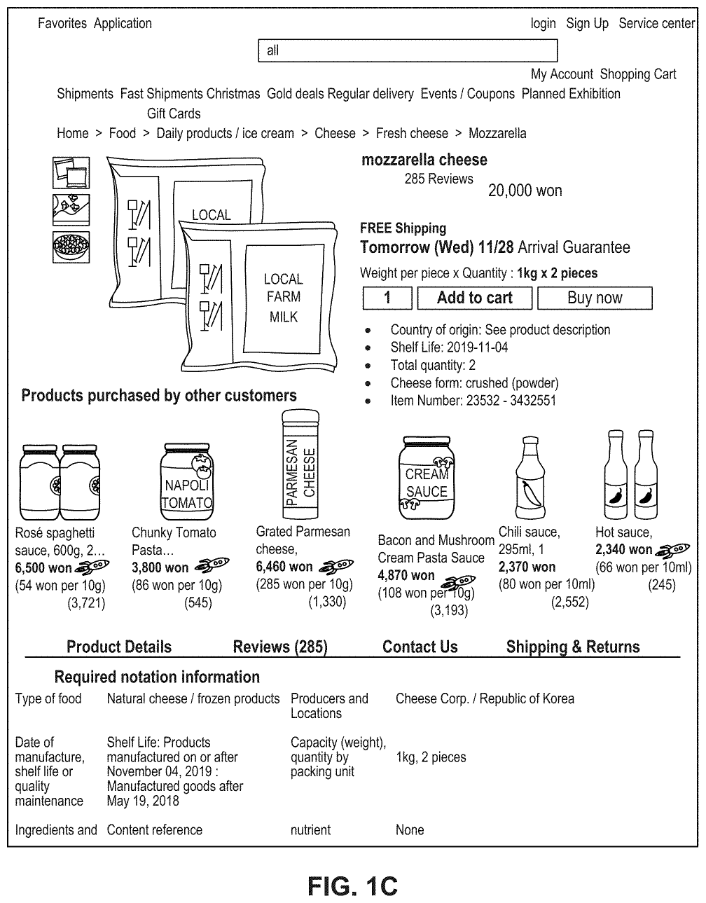

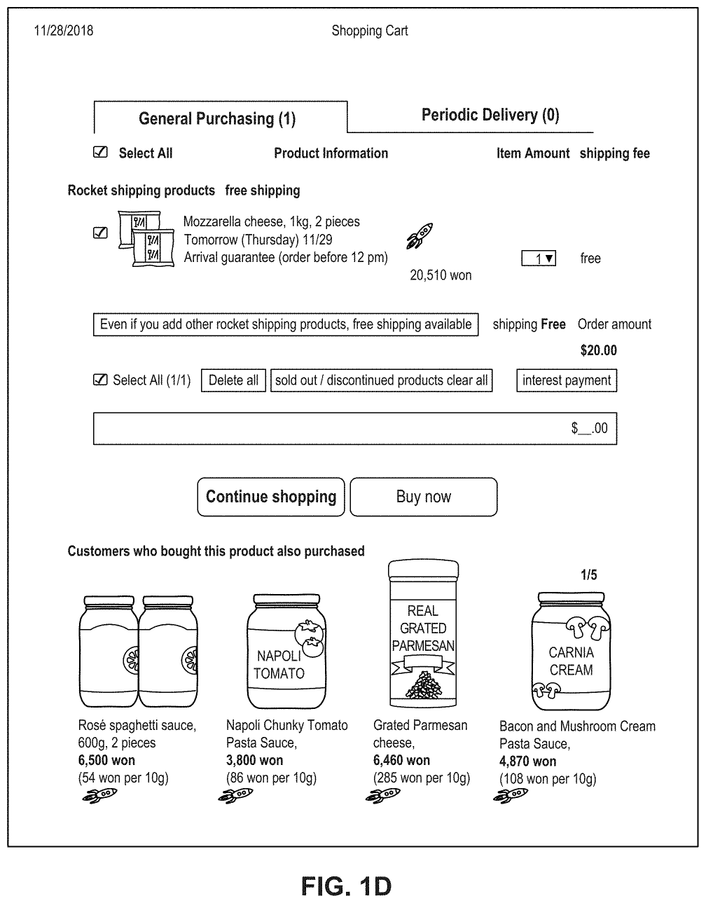

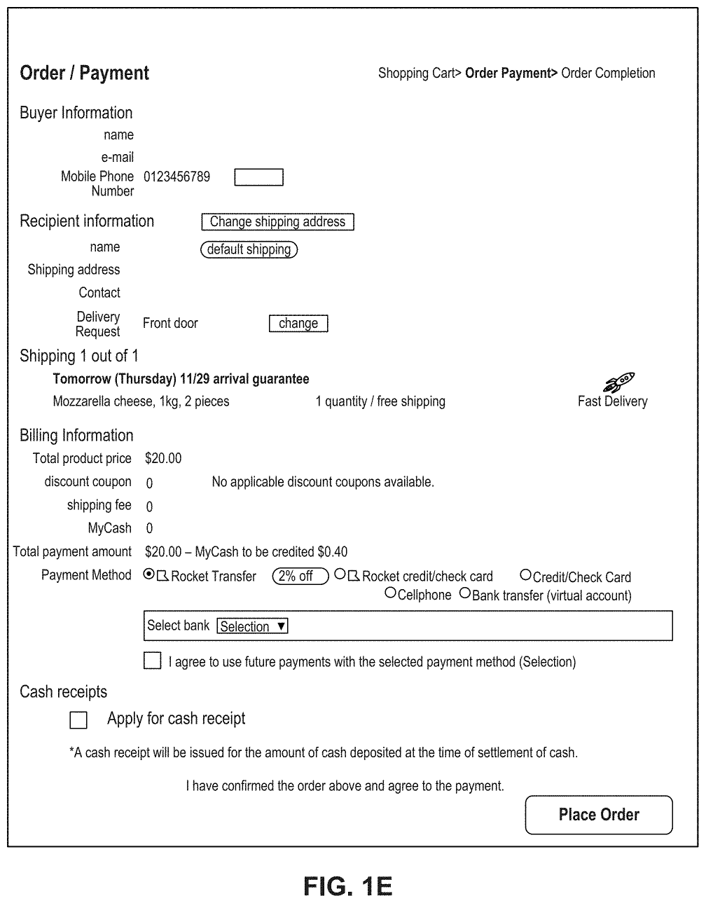

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

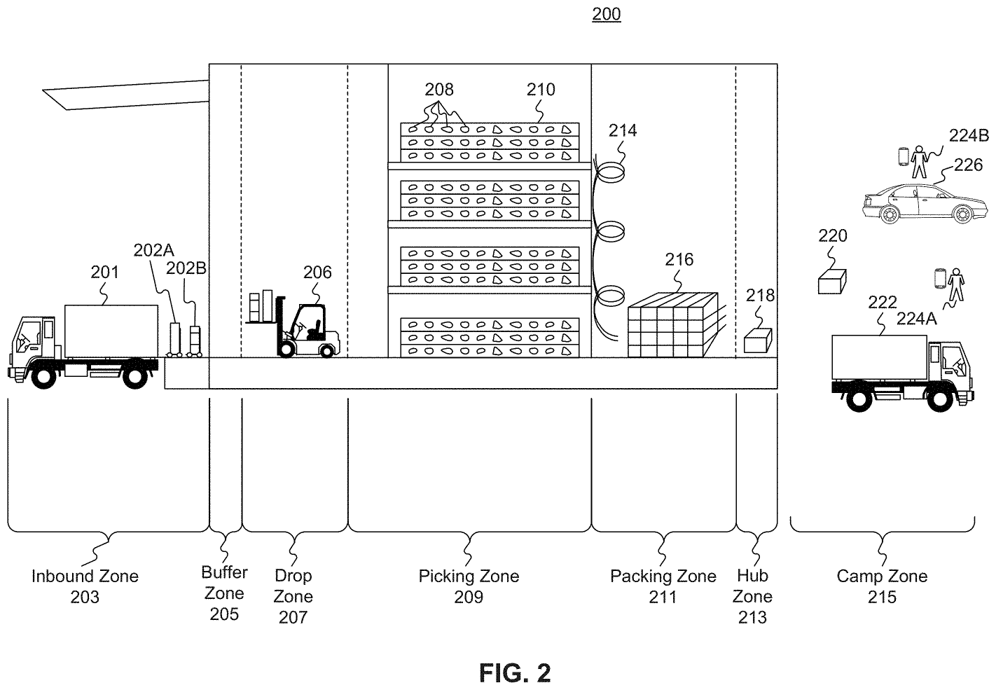

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

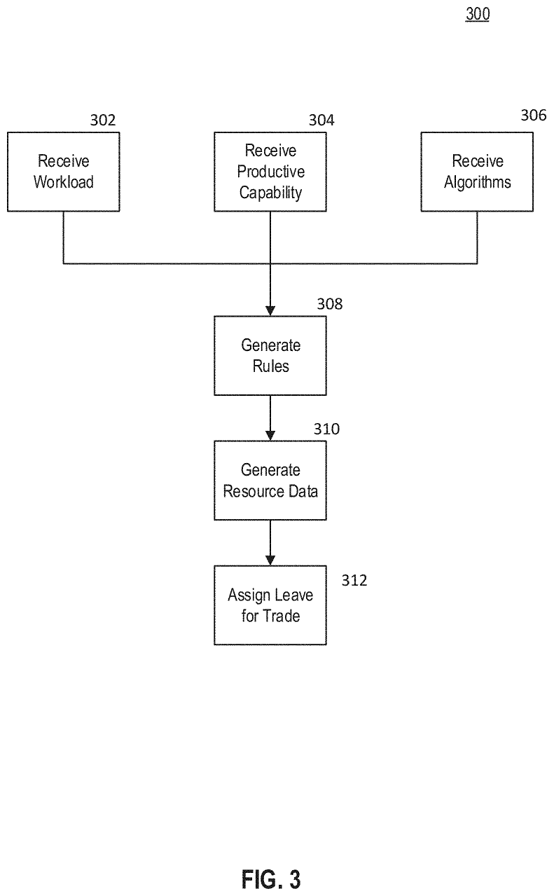

FIG. 3 is a flow chart of process 300, an exemplary embodiment of a method for automated shift scheduling of delivery workers. In the exemplary embodiment, process 300 is carried out by labor management system (LMS) 125.

In step 302, labor management system (LMS) 125 receives a demand forecast. The demand forecast may be a prediction of a workload of a work group for a predetermined time. The work group may be camp zone 215. The forecast workload prediction may be, for example, a prediction of a number of parcels to be delivered by camp zone 215, within a set time. In some embodiment, labor management system (LMS) 125 receives the demand forecast from shipment authority technology (SAT) system 101. In some embodiments, the predicted workload may be generated based on one or more of rule sets (e.g., correlating workload to one or more of a number of parcels to be delivered, an average number of parcels deliverable by a single delivery worker, or an expected amount of time for delivering one or more parcels). In other embodiments, the predicted workload may be generated based on machine learning techniques (e.g., using past data relating to workload as related to one or more of a number of parcels to be delivered, an average number of parcels deliverable by a single delivery worker, or an expected amount of time for delivering one or more parcels). In other embodiments, the predicted workload may be generated using artificial intelligence (AI) techniques (e.g., Markov processes, heuristics, neural networks, or genetic algorithms). Further, in other embodiments, labor management system (LMS) 125 may also receive the forecast workload prediction from transportation system 107 or any of the other system relevant to generating the demand forecast.

In step 304, labor management system (LMS) 125 receives a predetermined productivity capability. The predetermined productivity capability is information regarding available resources for completing a demand forecast. The predetermined productivity capability may be, for example, a number of delivery workers (such as delivery workers 224A and 224B) available for shifts for camp zone 215. In some embodiment, the predetermined productivity capability is stored in labor management system (LMS) 125. Alternatively, labor management system (LMS) 125 receives the predetermined productivity capability from shipment authority technology (SAT) system 101, from transportation system 107, or from any of the other system relevant to generating the predetermined productivity capability.

In step 306, labor management system (LMS) 125 receives algorithms for processing the workload prediction and the predetermined productivity capability. The algorithms may include mathematical formulas, logic, or analytical models. The algorithms are used by labor management system (LMS) 125 to produce a set of rules for generating resource data.

In step 308, labor management system (LMS) 125 generates a set of rules based on the algorithms. For example, in a non-limiting embodiment, labor management system (LMS) 125 may produce a rule specifying that a minimum of x number delivery workers must be available for on a particular day for camp zone 215. Labor management system (LMS) 125 may derive x by: receiving a forecast data indicating that y number of parcels are to be delivered by camp zone 215; receiving a predetermined productivity capability indicating that z numbers of delivery workers are assigned to camp zone 215; receiving an algorithm specifying that a single delivery worker can delivery w numbers of parcels per day; calculating that x number of delivery workers based on the forecast data, the predetermined productivity capability, and the algorithm received.

In step 310, labor management system (LMS) 125 generates the resource data for camp zone 215 based on the set of rules determined in step 308. The resource data may comprise a master schedule (e.g., a data structure) containing shifts and vacation times for each delivery worker in camp zone 215. The master schedule may span a fixed period of time, two weeks for example. During the fixed period of time, the master schedule will specify the times each delivery worker will report to work and may take vacation time. The master schedule may be stored in labor management system (LMS) 125, accessible via mobile devices.

In step 312, labor management system (LMS) 125 is configured to allow delivery workers in camp zone 215 to trade their assigned vacation times, subject to the rules derived in step 308 and the resource data. The trading process is described in detail below.

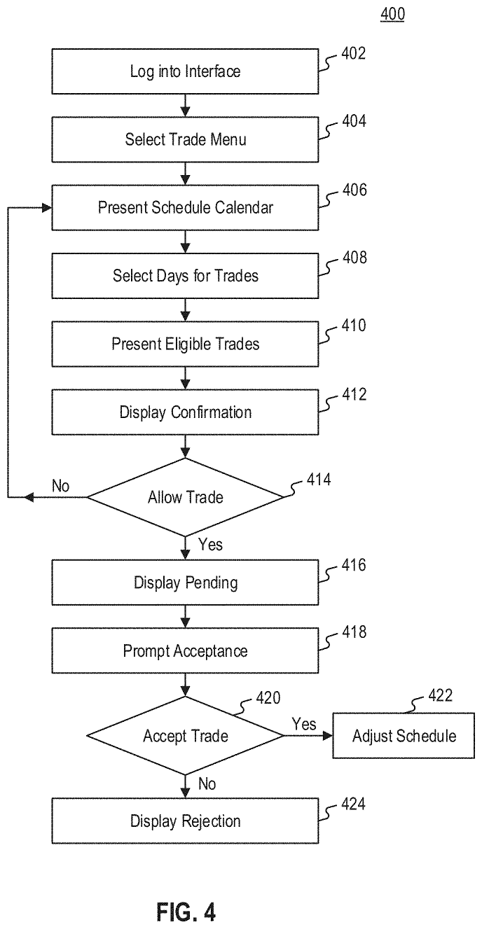

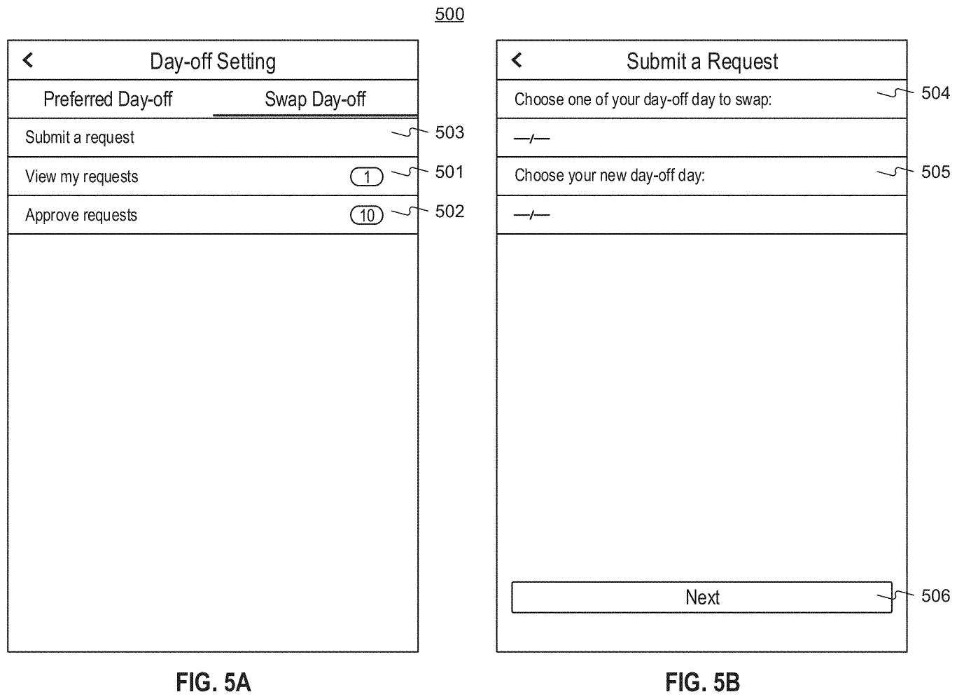

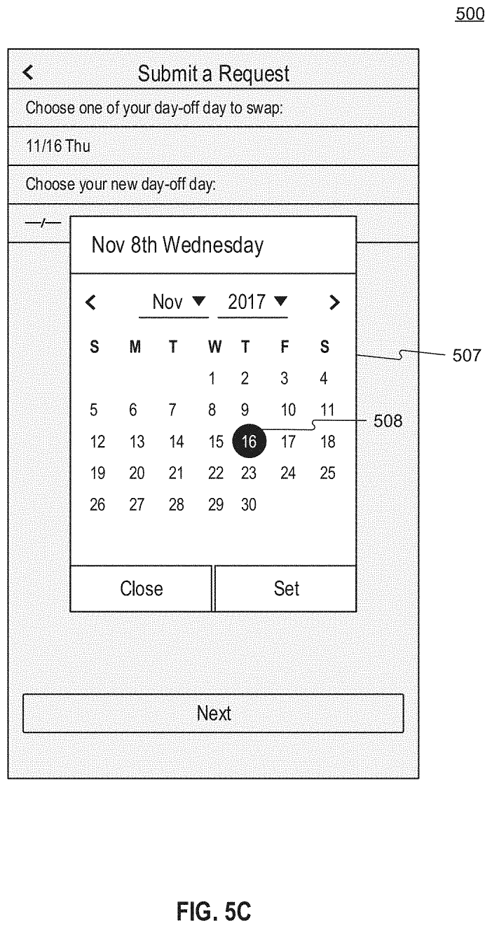

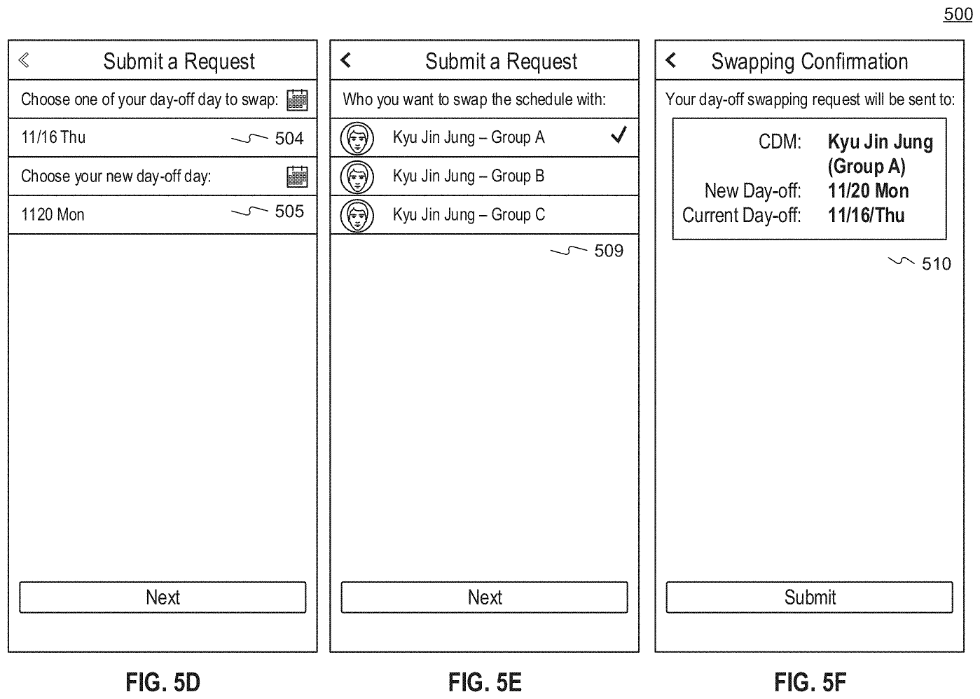

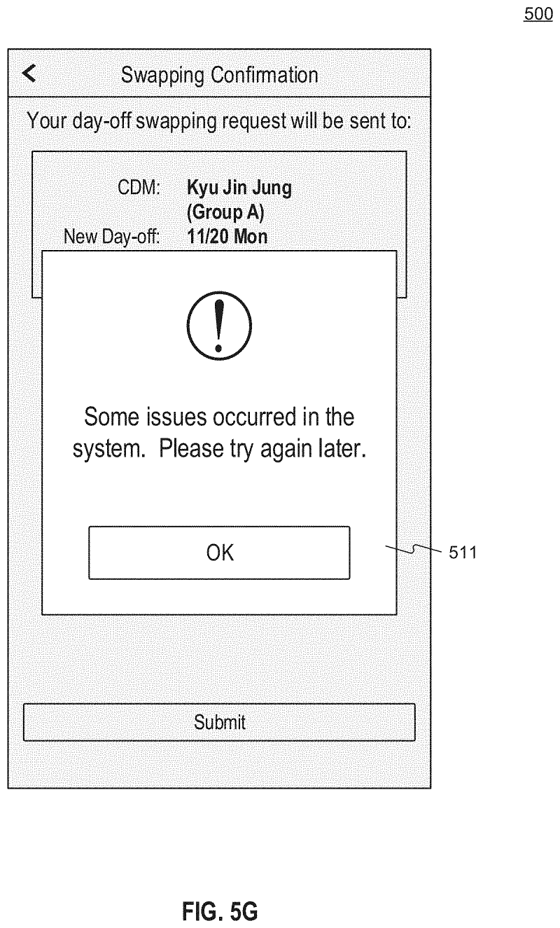

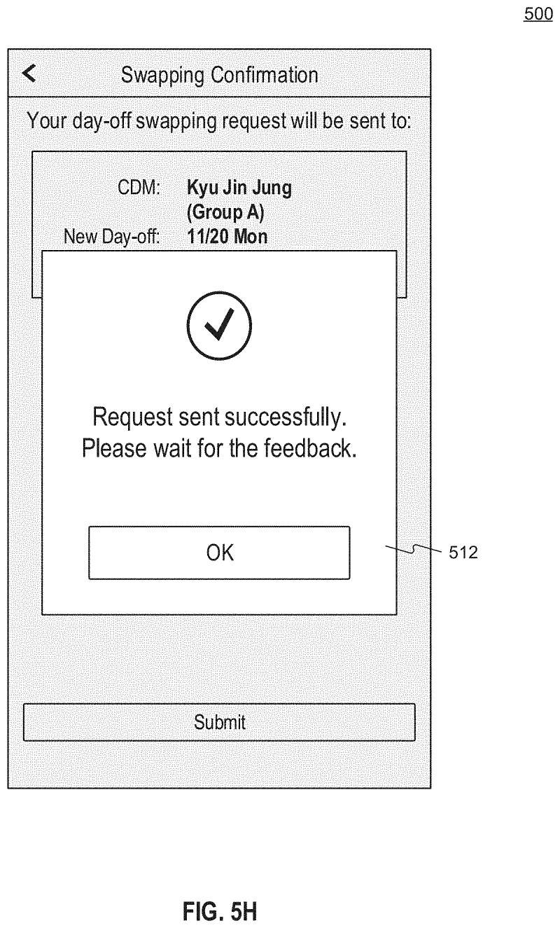

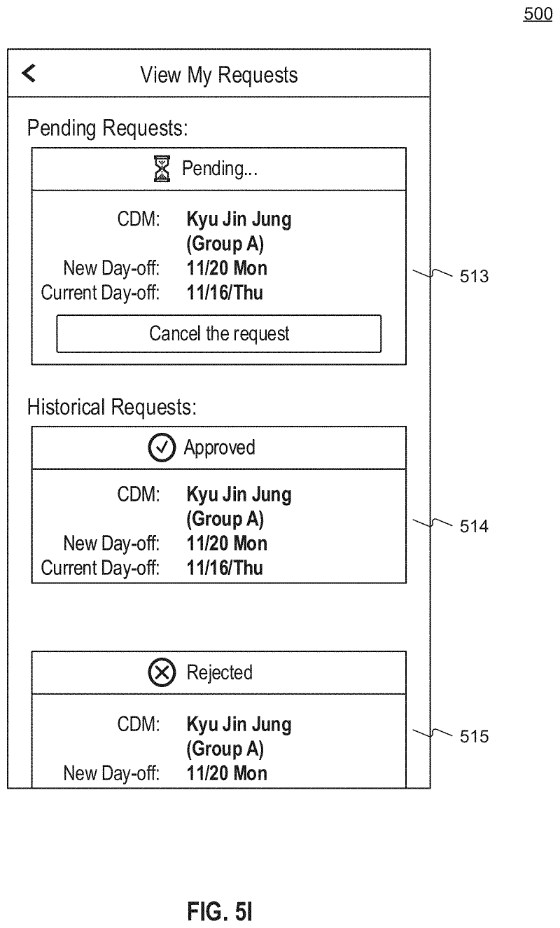

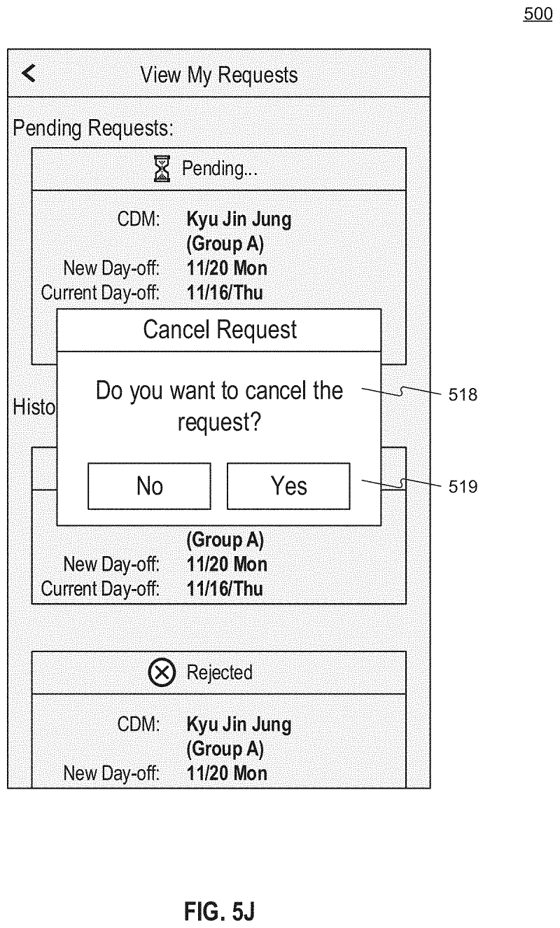

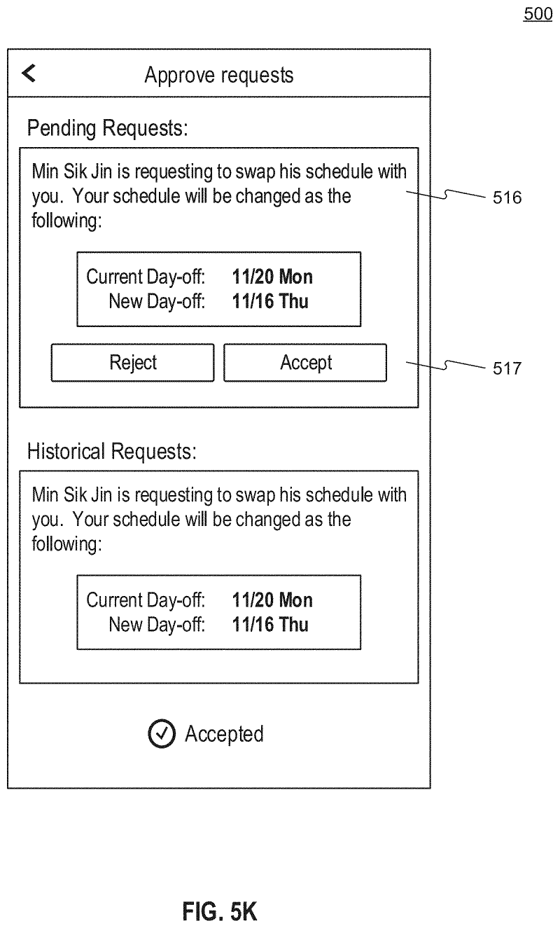

FIG. 4 illustrates a flow chart of process 400 for trading of vacation time. FIG. 5A-K illustrates exemplary embodiments of interactive user interfaces for trading of vacation time consistent with process 400.

In step 402, a first user, who may be a delivery worker belonging to camp zone 215, logs into labor management system (LMS) 125. The first user may log into labor management system (LMS) 125 by way of any one of the previously mentioned mobile devices (such as 107 and 109), or by way of any other computing devices capable of displaying interactive user interfaces. Labor management system (LMS) 125 generates an interactive user interface 500 configured to allow interaction with the first user. FIG. 5A illustrates a non-limiting embodiment of the interactive user interface 500. For example, FIG. 5A depicts an interactive user interface 500 that may be displayed to the first user upon logging into labor management system (LMS) 125 intending to perform vacation trading. The interactive user interface 500 may contain: a title caption indicating that the identity of the first user who is logged into labor management system (LMS)125 (not illustrated); a number of trade requests submitted by the first user, shown in 501; a number of trade requests waiting to be approved by the first user from another user, shown in 502. In addition, the interactive user interface may contain graphic user interface (GUI) 503 configured to receive user inputs, which may include a GUI to receive selection in order to advance to another generated interactive user interface. In some embodiments, another display may be a pop-up display, or another newly generated interactive user interface.

In step 404, the first user selects corresponding GUI 503 on the interactive user interface 500 in order to submit a new vacation trading request. In the non-limiting example, the first user may select “Submit a request” (503 illustrated in FIG. 5A) in order to submit a new vacation trading request and advance to another interactive user interface illustrated in FIG. 5B.

FIG. 5B depicts a non-limiting embodiment of an interactive user interface 500 configured to allow the first user to provide input to labor management system (LMS) 125. For example, the first user may select “Choose one of your day-off day to swap:”, 504, and “Choose your new day-off day:”, 505, to cause labor management system (LMS) 125 to display a new interactive user interface containing one or more calendar.

In Step 406, labor management system (LMS) 125 generates one or more calendar for a predetermined time period, based on the master schedule generated in step 310. The predetermined time period may be a time span of the master schedule. For example, if the master schedule of the delivery workers are scheduled every two weeks, then the one more calendar will only display the dates for the two weeks associated with the master schedule. FIG. 5C illustrates a non-limiting embodiment of the one or more calendars 507. From calendar 507, the first user may select a specific date 508 for each of “Choose one of your day-off days to swap:” 504, and “Choose your new day-off day:” 505, respectively. In some embodiments, alternative interactive user interfaces for date selection may be contemplated that are consistent with the present invention. For example, in step 406, desired dates for trading may be selected from a drop-menu, a list, or be entered directly.

In step 408, the first user selects, via the methods discussed above, one or more of his/her assigned vacation time and one or more of his/her desired vacation time. Labor management system (LMS) 125 may display the selection in an interactive user interface 500, such as one illustrated in FIG. 5D.

In step 410, labor management system (LMS) 125 presents a list of eligible trades. In the non-limiting example, FIG. 5E illustrates an interactive user interface 500 of the list of eligible trades 509. The list of eligible trades 509 is generated to include all delivery workers who have the vacation times desired by the first user. For example, the vacation time that the first user desires may have been assigned to other delivery workers in master schedule, and thus labor management system (LMS) 125 display a list of other delivery workers having the desired vacation time. Labor management system (LMS) 125 is configured to receive inputs from the first user in order select, from the list presented, one of the other delivery workers to initiate trade request for the desired vacation time.

In step 412, labor management system (LMS) 125 displays a confirmation of the trade request. The confirmation may include information related to the trade request such as names of the individual selected for trade, the assigned vacation time to be offered, and desired vacation time. A non-limiting example of the interactive user interface screen 500 having a confirmation 510 of the trade request is illustrated in FIG. 5F. The first user is also prompted to confirm the proposed trade request for submission.

In step 414, labor management system (LMS) 125 determines whether the proposed trade request is allowed. In one embodiment, the set of rules determined in step 308 may be used in step 414 to determine if the proposed trade is allowed. For example, the set of rules specify that a minimum number of delivery workers (224A and 224B) must be available on a specific day based on a predicted workload and a predetermined productivity capability. Thus, labor management system (LMS) 125 will not allow the proposed trade request if the proposed trade request would result in less than the minimum number of delivery workers available for shift for one of the dates involved in the proposed trade request. In some embodiments, additional or alternative rules may govern whether the proposed trade request will be allowed. For example, a supervisor or an authorized personnel may access labor management system (LMS) 125 to impose additional restrictions on the proposed trade requests when needed.

If labor management system (LMS) 125 determines that the proposed trade request is not allowed, then “Allow Trade” is set to “No,” and process 400 repeats at step 404. In addition, labor management system (LMS) 125 may generate an interactive user interface containing an error message if the proposed trade request is not allowed, informing the first user that the proposed trade request cannot be completed. FIG. 5G illustrates a non-limiting example of an interactive user interface 500 containing an error message 511.

If labor management system (LMS) 125 determines that the proposed trade request is allowed, then “Allow Trade” is set to “Yes,” and process 400 proceeds to step 416. In addition, labor management system (LMS) 125 may display a confirmation message if the proposed trade request is allowed, informing the first user that the proposed trade has been submitted. FIG. 5H illustrates a non-limiting example of an interactive user interface 500 containing a confirmation message 512.

In step 416, labor management system (LMS) 125 may display a list of vacation trade requests. For example, labor management system (LMS) 125 may generate for display a list of all vacation trades submitted by the first user. The list may contain indications, for each trade request, whether the trade requests were denied, approved, or are currently pending. Alternatively, the list may contain only the most recent trade requests. FIG. 5I illustrates a non-limiting example of an interactive user interface 500 of a list of vacation trade requests. For example, the interactive user interface contains vacation trade requests that are currently pending, have been approved and have been denied. In some embodiment, the interactive user interface of trade requests may be displayed based on category, so that trade requests belonging in a same category are grouped together in the interactive user interface. In other embodiments, the trade requests belonging in the same category may be associated with a common graphic icon. In the non-limiting example, FIG. 5I illustrates trade requests that are categorized as pending, shown in 513, approved, shown in 514, and denied, shown in 515. Graphic icons such as an hourglass, a check mark or a cross mark may be used for each of the respective categories.

In step 418, labor management system (LMS) 125 transmits to a second user from whom the proposed trade request requires approval. For example, if the first user submits a request to trade to the second user, the trade request requires approval from the second user. Labor management system (LMS) 125 is configured to generate an interactive user interface soliciting approval on a display interface belong to the second user. As previously discussed, labor management system (LMS) 125 may generate this interactive user interface on any one of the mobile devices (107, 109) discussed in the previous section, or on any computer terminals that the second user may access.

FIG. 5K illustrates a non-limiting embodiment of an interactive user interface 500 containing solicitation for approval to the second user. The display contains a message 516 explaining the proposed trade request, and details of the proposed trade request. For example, the interactive user interface contains the vacation time sought by the first user, the vacation time offered by the first user, and GUIs 517 configured to allow for accepting or rejection of the proposed trade request. Additionally or alternatively, the display may also contain a history of prior approvals or denials.

If the second user accepts the proposed trade request in step 420, labor management system (LMS) 125 adjust the vacation times for both the first and second users to reflect changes in their respective assigned vacation time. For example, labor management system (LMS) 125 updates the master schedule to reflect the new vacation times for the first and second users.

If the second user rejects the proposed trade request in step 420, labor management system (LMS) 125 leaves the master schedule unchanged. In some embodiment, labor management system (LMS) 125 may provide notification to the first user that the proposed trade request has been denied.

In some embodiments, the first user may wish to cancel the proposed trade request for some reason. At any time before the proposed trade request has been approved by the second user, the first user may access a list of pending trade requests from an interactive user interface 500, such as one illustrated in FIG. 5J. Labor management system (LMS) 125 configures the interactive user interface 500 to generate a prompt 518 containing a GUI 519 to allow the first user to select trade requests that are currently pending for cancellation. Labor management system (LMS) 125 will remove any canceled requests from the system.

One of ordinary skill will appreciate multiple advantages the above described system and method for vacation trading. For example, the disclosed embodiments enable an individual delivery worker, who may be assigned a mobile device or have access to computing terminals, the ability to electronically and seamlessly trade his/her assigned vacation time. This solves a practical problem of balancing the need for delivery resources and the need for delivery workers to have vacation time they desire. The method and system for vacation trading provide a technical solution to the above problem by leveraging an integrated system of servers and mobile devices to allows for fast and convenient trading of vacation times among the delivery workers. The method and system for vacation trading obviates the need for each delivery worker to be aware of other delivery workers' shifts or the daily business need. This allows for a wider pool of potential vacation time to be traded and reduces supervisory burden. Moreover, the integrated system of servers and mobile devices enables real-time updates to delivery worker shifts, which improves overall system efficiency.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A networked server system for automated personnel scheduling, comprising:
at least one memory storing computer-executable instructions; and
at least one processor configured to execute the stored instructions to:
retrieve, from a first server, resource data for a predetermined time period;
generate instructions for displaying on an interactive graphical user interface of a mobile device, schedule information for a first user included in the resource data, wherein the interactive graphical user interface comprises an interactive calendar configured to display the schedule information corresponding to the predetermined time period and to receive a selection of the schedule information via the interactive graphic user interface;
generate, based on the selection of schedule information, an interactive list for display on the interactive user interface, the interactive user interface being configured to display candidate users and to receive a selection of one or more candidate users via the interactive user interface;
generate one or more graphic icons configured to receive inputs for confirming the selection of the one or more candidate users and for switching between the interactive calendar and the interactive list;
receive a request from the mobile device associated with the first user to trade a shift during the predetermined time period based on the selection of the schedule information and the selection of the one or more candidate users;
apply one or more rule sets to identify a selected candidate user from among the one or more candidate users in the resource data based on the received request to initiate a shift trade;
generate on the interactive graphical user interface, an interactive confirmation prompt configured to receive input to transmit the received request to the identified candidate user;
generate on the interactive graphical user interface, based on the received input to transmit the request, at least one interactive table representing the request, the at least one interactive table being configured to receive an instruction to display an interactive recission
prompt, wherein the interactive recission prompt is configured to receive an input to rescind the request during a pendency period; and
update the resource data in real time to reflect the received request transmitted to the identified candidate user.

2. The system of claim 1, wherein the resource data comprises scheduled shift information, scheduled vacation information, and workgroup information associated with a plurality of users.

3. The system of claim 2, wherein the selected candidate user is identified based on a planned vacation reflected in the vacation information.

4. The system of claim 3, wherein the selected candidate user is further identified based on a match in workgroup information between the first user and the candidate user.

5. The system of claim 1, wherein the received request identifies a date of the shift during the predetermined time period, and the identified candidate user is associated with a planned vacation on the date.

6. The system of claim 1, wherein the traded shift reflected in the resource data associates the shift during the predetermined time period with the selected candidate user, and associates the planned vacation with the first user.

7. The system of claim 1, wherein the resource data reflects a required number of individuals for the predetermined time period, and
the required number of individuals is determined based on a predetermined productivity capability of the required number of individuals and a predicted workload for the predetermined time period

8. The system of claim 7, wherein the at least one processor is further configured to confirm that the required number of individuals is satisfied after acceptance of the traded shift.

9. The system of claim 7, wherein the predicted workload is determined based on a quantity of parcels to be delivered during the predetermined time period, and the predetermined productivity capability is an amount of the parcels that each individual can deliver during the predetermined time period.

10. A computer-implemented method for automated personnel scheduling, the method being performed by at least one processor of a networked server executing stored instructions to perform steps comprising:
retrieve, from a first server, resource data for a predetermined time period;
generate for displaying on an interactive graphical user interface of a mobile device, schedule information for a first user included in the resource data, wherein the interactive graphical user interface comprises an interactive calendar configured to display displaying the schedule information corresponding to the predetermined time period, and to receive a selection of the schedule information via the interactive graphic user interface;
generate, based on the selection of schedule information, an interactive list for display on the interactive user interface, the interactive user interface being configured to display candidate users and to receive a selection of one or more candidate users via the interactive user interface;
generate one or more graphic icons configured to receive inputs for confirming the selection of the one or more candidate users and for switching between the interactive calendar and the interactive list;
receive a request from the mobile device associated with the first user to trade a shift during the predetermined time period based on the selection of the schedule information and the selection of the one or more candidate users;
apply one or more rule sets to identify a candidate user from among the one or more candidate users in the resource data based on the received request to initiate a shift trade;
generate on the interactive graphical user interface, an interactive confirmation prompt configured to receive input to transmit the received request to the identified candidate user;
generate on the interactive graphical user interface, based on the received input to transmit the request, at least one interactive table representing the request, the at least one interactive table being configured to receive an instruction to display an interactive recission prompt, wherein the interactive recission prompt is configured to receive an input to rescind the request during a pendency period; and
update the resource data in real time to reflect the received request transmitted to the identified candidate user.

11. The method of claim 10, wherein the resource data comprises scheduled shift information, scheduled vacation information, and workgroup information associated with a plurality of users.

12. The method of claim 11, wherein the selected candidate user is identified based on a planned vacation reflected in the vacation information.

13. The method of claim 12, wherein the selected candidate user is further identified based on a match in workgroup information between the first user and the candidate user.

14. The method of claim 10, wherein the received request identifies a date of the shift during the predetermined time period, and the identified candidate user is associated with a planned vacation on the date.

15. The method of claim 10, wherein the traded shift reflected in the resource data associates the shift during the predetermined time period with the selected candidate user, and associates the planned vacation with the first user.

16. The method of claim 10, wherein the resource data reflects a required number of individuals for the predetermined time period, and
the required number of individuals is determined based on a predetermined productivity capability of the required number of individuals and a predicted workload for the predetermined time period.

17. The method of claim 16, wherein the at least one processor confirms that the required number of individuals is satisfied after acceptance of the traded shift.

18. The method of claim 16, wherein the predicted workload is determined based on a quantity of parcels to be delivered during the predetermined time period, and the predetermined productivity capability is an amount of the parcels that each individual can deliver during the predetermined time period.

19. The method of claim 16, further comprising providing an electronic notification in a graphical user interface to the first user and the selected candidate user, the electronic notification including information about the updated resource data.

20. A computerized method for automated personnel scheduling, the method being performed by at least one processor of a networked server executing stored instructions to perform steps comprising:
determining, using order data received from a networked order database, a quantity of parcels to be delivered during a predetermined time period;
determining, based on the quantity of parcels, a predicted workload for the predetermined time period;
generate instructions for displaying an interactive graphical user interface including:
schedule information for a first user included in the resource data;
display an interactive calendar configured to display the schedule information and to receive a selection of the schedule information via the interactive graphic user interface;
display, based on the selection of schedule information, an interactive list for display on the interactive user interface, the interactive user interface being configured to display candidate users and to receive a selection of one or more candidate users via the interactive user interface;
display one or more graphic icons configured to receive inputs for confirming the selection of the one or more candidate users, for switching between the interactive calendar and the interactive list, and
for initiating and accepting changes to the schedule information;
receive, via selection of the one or more graphic icons, a request from a mobile device associated with the first user to trade a shift during the predetermined time period;
apply one or more rule sets to identify a candidate user from among the one or more candidate users in the resource data based on the received request to initiate a shift trade, wherein the one or more rule sets filters a set of users based on a starting time and an ending time of the shift, and filters the set of users based on a predetermined productivity capability of the first user;
display an interactive confirmation prompt configured to receive input to transmit the received request to the identified candidate user;
display an interactive recission prompt configured to receive an instruction to rescind the request during a pendency period; and
providing an electronic notification to the mobile device associated with the first user and the identified candidate user, the electronic notification reflecting the shift trade.
